(19) United States
(12) Patent Application Publication
(10) Pub. No.: US 2014/0230385 A1
(43) Pub. Date: Aug. 21, 2014

(54) PLEATED FILTER WITH AUTOMATIC LOWER END HOLD DOWN

(71) Applicant: RPS Products, Inc., Hampshire, IL (US)

(72) Inventors: Daniel E. Schuld, Inverness, IL (US); Donald N. Jursich, Crystal Lake, IL (US); Paul G. Juettner, Chicago, IL (US)

(73) Assignee: RPS Products, Inc., Hampshire, IL (US)

(21) Appl. No.: 14/259,963

(22) Filed: Apr. 23, 2014

Related U.S. Application Data
(63) Continuation-in-part of application No. 13/705,998, filed on Dec. 5, 2012.

(51) Int. Cl. B01D 46/00

(52) U.S. Cl. CPC B01D 46/0004
USPC 55/481; 493/394

(57) ABSTRACT

A filter for insertion into an air filter enclosure includes a pleated, collapsible filter having a flexible support member and a filter media layer, a top end cap and a bottom end cap. Side edges of the filter media layer cover the edges of the support member. The top end cap is configured for slidably mechanical attachment to a top portion of the enclosure. Weights and/or magnets are provided on the bottom end cap. The top end cap is guided into the top portion of the enclosure, after which the pleated media is released causing the bottom end cap to drop within the enclosure and magnetically attach itself to the bottom of the enclosure.

### PRIORITY

The present application is a continuation-in-part of copending U.S. Ser. No. 13/705,998 filed Dec. 5, 2012.

### BACKGROUND

Pleated filter media, such as collapsible pleated mechanical media (ESPM) filters, occupy substantially less space in their collapsed state, compared to equivalent cartridge configurations. Thus, they are easier to store and ship, and consequently have lower storage and shipping costs. However, collapsible filters are substantially less user-friendly than equivalent cartridge-style filters, which can be easily inserted into and removed from the filter enclosure with only minimal user interaction. In contrast, collapsible filters can require assembly by the end user before they are ready to be installed into the filter housing. For example, one such air cleaner includes an enclosure, upper and lower guide tracks, and a door. Effort is required to properly install the filter into the upper and lower guide tracks. Thus, there exists a need for a collapsible filter that can be installed into the filter enclosure with minimal effort by the end user.

### SUMMARY OF THE INVENTION

In accordance with the invention, an improved pleated, collapsible filter for an air cleaner is provided. The air cleaner includes a filter enclosure having a width W₁, top and bottom guide tracks, at least the bottom track being comprised of a ferrous metal, wherein the air cleaner is configured to cause air to flow through the enclosure from an upstream to a downstream direction. The filter comprises a flexible metal support member having a first and second side edges, said support member having a width W₂ substantially equal to but less than W₁. The filter media layer is connected to and covers at least one side of the support member and has an unfolded width W₃ greater than W₂, such that the filter media when unfolded extends beyond the first and second side edges of the support member forming filter media skirts. The filter media skirts are folded over the respective first and second side edges of the support member so as to cover the side edges and form filter media cushions on the side edges of the filter, the filter with folded over skirts having a width W₄ that is substantially equal to W₁. The filter is configured to be positioned in the enclosure with the support member downstream from the filter media with respect to the direction of airflow. A top end cap is connected to a top end portion of the filter, and is configured for slideable engagement into the top guide track of the filter enclosure. A bottom end cap is connected on an inner surface to a bottom end portion of the filter, and is weighted so that the bottom end cap falls to the bottom of the enclosure thereby expanding the pleated filter within the filter frame enclosure. Preferably, the bottom end cap also includes at least one magnet on an outer surface. The magnet is configured for magnetic attachment to the bottom guide track of the filter enclosure to further secure the bottom of the filter within the enclosure.

A method of making a filter comprises providing a flexible support member having a width W₂ between side edges, providing a layer of filter media having a width W₃, W₃ being greater than W₂, attaching the support member to the filter media so that the filter material extends beyond the side edges of the support member forming filter media skirts, folding the filter media skirts over the sides edges of the support member to cover the side edges, attaching the skirts to the other side of the support member to form a composite filter media, and then pleating the composite filter media. Top and bottom end caps are formed, preferably by extrusion molding. The top end cap is configured to be slidably attached to a top guide track of a filter enclosure. The method further includes attaching magnets to an outer surface of the bottom end cap, and attaching the end members to opposite ends of the pleated composite filter media.

A method of replacing a filter in a filter frame enclosure comprises providing a replacement filter comprised of a pleated, collapsible filter having top and bottom end caps, the bottom end cap being weighted and/or having at least one magnet. The method further comprises opening the filter frame enclosure, removing an old filter from the filter frame enclosure, and guiding the top end member only of the replacement filter into a top guide track of the filter frame enclosure. The method further includes sliding the replacement filter into the filter frame enclosure with the filter in at least a partially collapsed configuration, then releasing replacement filter allowing the bottom of the filter to drop within the filter frame enclosure. The weight of the bottom end cap holds the lower end of the filter in position within the enclosure. Further, the optional magnet on the bottom end cap magnetically attaches itself to a ferrous metal bottom member of the filter frame enclosure.

Further features and advantages of the invention will become apparent from the following detailed description when read in reference to the drawings.

### BRIEF DESCRIPTION OF THE DRAWINGS

FIG. 1 is an isometric exploded view of a frame and a filter according to the invention.

FIG. 2 is a longitudinal cross-sectional view of the frame and filter of FIG. 1.

FIG. 3 is a partial cross-section of the filter taken along line 3-3 of FIG. 2.

FIG. 4 is an enlarged detail of the frame and filter taken along line 4-4 of FIG. 3.

FIG. 5A is a plan view of a support member and the filter media layer.

FIG. 5B is a plan view of the filter media layer partially folded over the support member.

FIG. 5C is a plan view of the filter media layer folded over the support member.

FIG. 6 is a partial cross-section of the filter taken along line 6-6 of FIG. 2.

FIG. 7 is a bottom plan view of the bottom end cap.

FIG. 8 is a partial cross-section view of an alternative bottom member similar to FIG. 6.

### DETAILED DESCRIPTION

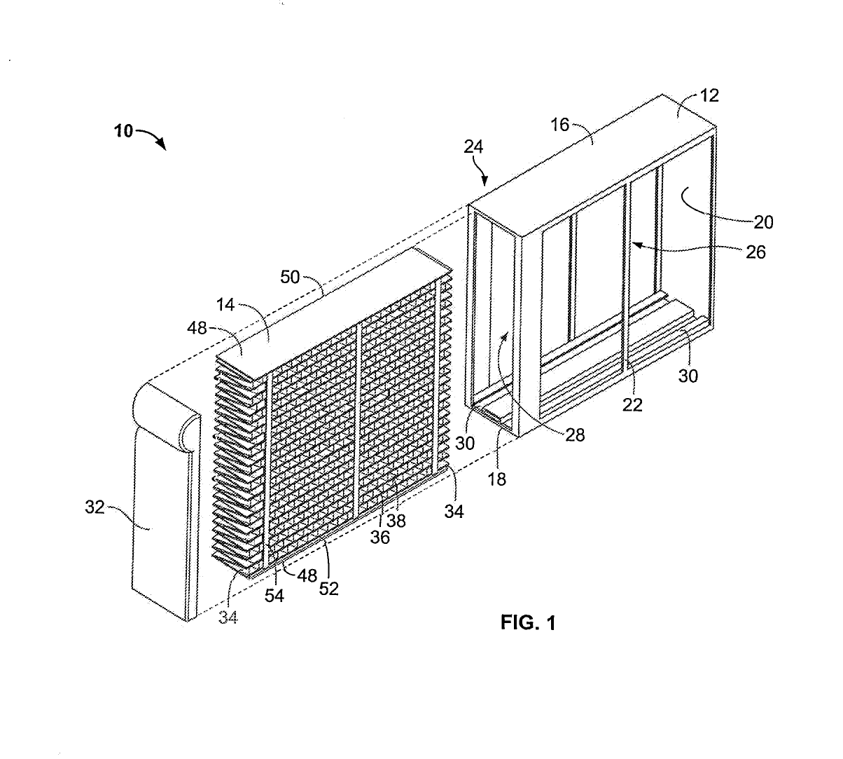

Referring to FIG. 1, an air cleaner is generally designated 10 and includes a frame enclosure 12 and a filter 14. The frame enclosure 12 includes a top wall 16, a bottom wall 18, a rear wall 20, and a reinforcement member 22. The enclosure 12 has an upstream air-inlet opening 24 and a downstream air-outlet opening 26. In addition, the enclosure 12 has a filter opening 28 that is opposite the rear wall 20. The enclosure 12 can further include guide tracks 30 adjacent to the top wall 16 and the bottom wall 18 and that extend from at or near the rear wall 20 to at or near the filter opening 28. The guide tracks and walls are conventionally formed of a ferrous metal, such as steel. A door 32 is attachable to the frame enclosure 12 to close the filter opening 28.

Filter 14 is preferably a pleated filter media such as a collapsible extended surface pleated mechanical media filter (ESPM) type such that the filter occupies substantially less space in its collapsed stated than in its expanded state. Typically, filter 14 is transported and sold in a collapsed state. At the time of installation, the filter is expanded, as shown in FIG. 1. The filter 14 is configured to be insertable into the frame enclosure 12 through the filter opening 28. When inserted, the filter 14 extends between the top and bottom walls, 16 and 18 respectively, between the rear wall 20 and the filter opening 28, and between the air-inlet opening 24 and the air-outlet opening 26. Consequently, when the door 32 is closed, air can be directed to flow through the air cleaner 10 from the air-inlet opening 24, through the filter 14, and then exiting through the air outlet-opening 26.

As shown in FIGS. 1-3, filter 14 includes a filter media layer 34 and flexible support member 36. As is well known in the art, the filter media may be made of non-woven natural or synthetic fibers capable of extracting impurities from the air. However, the filter media layer 34 can be made of other known or later-developed materials.

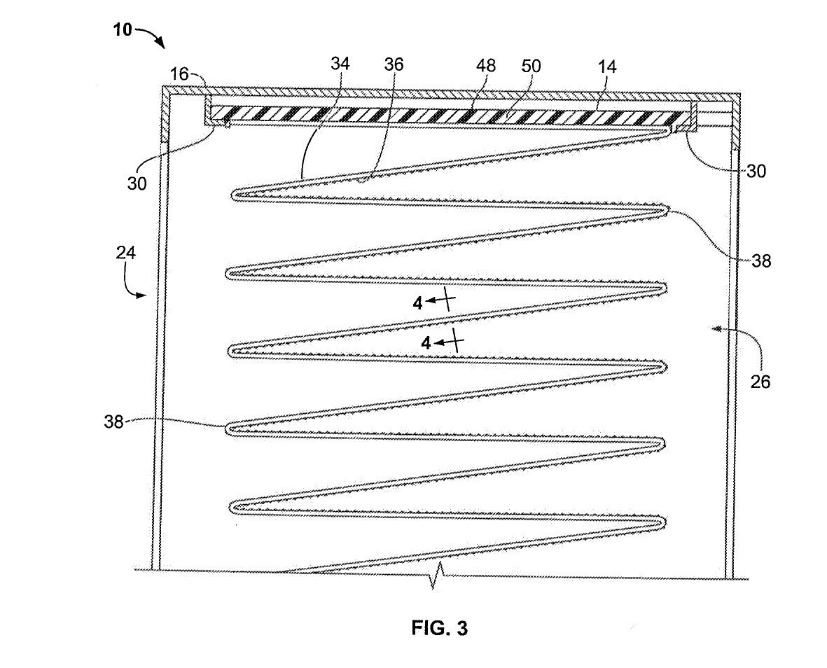

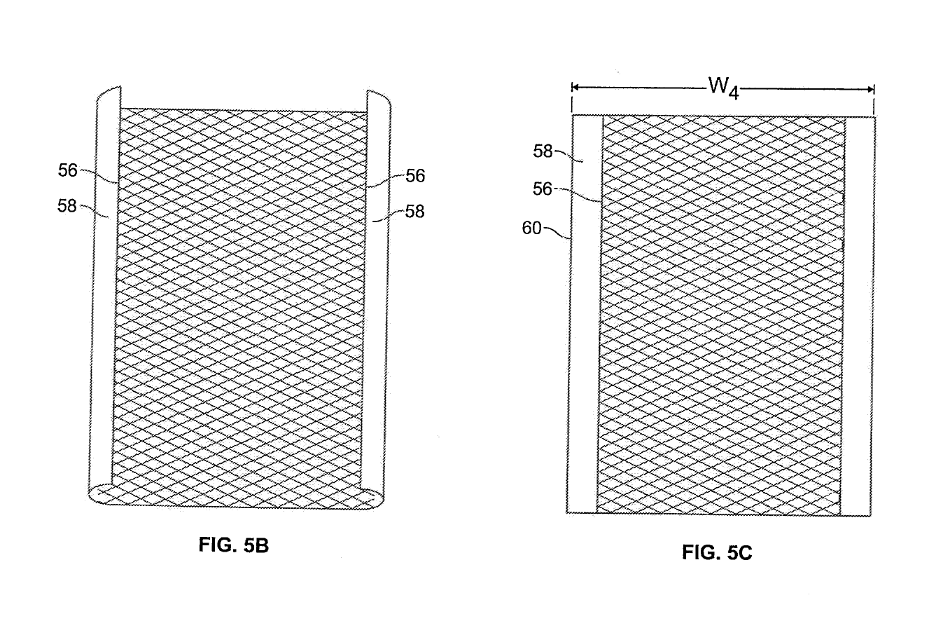

The support member 36 is porous and flexible and is preferably fabricated from slit and expanded metal foil. However, the support member 36 could be made of plastic or other material. The support member 36 is more rigid than the filter media layer 34 and is preferably positioned on the downstream side of the filter media layer 34 in a direction of airflow as shown in FIG. 3. The filter support member 36 provides support to the filter media layer 34 to maintain a generally pleated shape of the filter 14. As shown in FIGS. 5A-5C, the filter support member 36 has side edges 40, 41, a top edge 42, a bottom edge 43, a first side surface 44, and a second side surface 46.

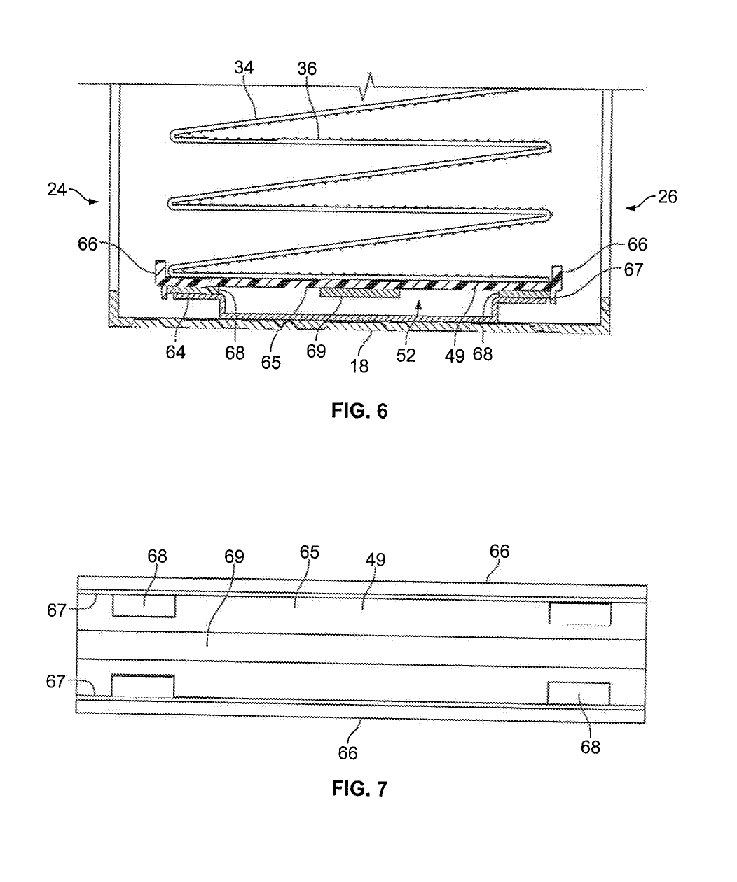

Referring to FIGS. 3 and 6, the filter 14 preferably includes a set of end caps 48, 49 at the top and bottom ends 50 and 52, respectively, of the filter 14. Each end cap is attached to the filter media layer 34, the filter support member 36, or both. Each end cap is configured to engage the guide tracks 30, thereby securing the end caps and the filter 14 in the enclosure 12. More specifically, top end cap 48 is configured to be aligned with and slidably engage top guide track 30 of frame 12 as shown in FIG. 3.

FIGS. 6 and 7 illustrate a preferred bottom end cap 49. End cap 49 includes a base member 65, optional stiffening ribs 66, 67, at least one, preferably plural, and more preferably four magnets 68, and a weight 69. A first pair of ribs 66 is provided on an inner side of the base member 65, which aids in locating and attaching the bottom of the composite filter 34, 36. A second pair of stiffening ribs 67 is provided on an outer side of side of the end cap, which aids in locating the magnets 68 during manufacture. The magnets are in between an abutted to ribs 67. In one embodiment the end cap with ribs is extruded from plastic and the magnets 68 are attached in any manner, preferably with an adhesive backing. Alternatively, the bottom end cap 49 can be extruded of a magnetic material whereby the entire bottom end cap 49 is magnetic. The magnet(s) are configured to engage and magnetically attach to steel bottom guide members 64 of the frame enclosure 12. If the filter enclosure does include guide members 64, the magnets can be configured for attachment to any ferrous material bottom member of the enclosure. The end cap 49 further comprises a weight 69 attached to the base member 65. The weight can be attached in any manner, such as with adhesive backing. The amount of weight added is that sufficient based on operating conditions to hold the bottom end cap down, either by weight alone or by the combination of weight and magnetic attachment. In one embodiment, a weight of at least 5 oz per lineal foot is added to a plastic base member, and in one preferred embodiment 5-8 oz per lineal foot is added. The weight may be comprised of any material, including metal, such as steel. Alternatively the bottom end cap 49 may be fabricated from a heavier material, such as steel, so that the design weight is thereby incorporated into the bottom end cap. As a result, the bottom end cap 49 is secured to the bottom of the enclosure 12 by the weight of the end cap, or by magnetic attachment, or by a combination thereof.

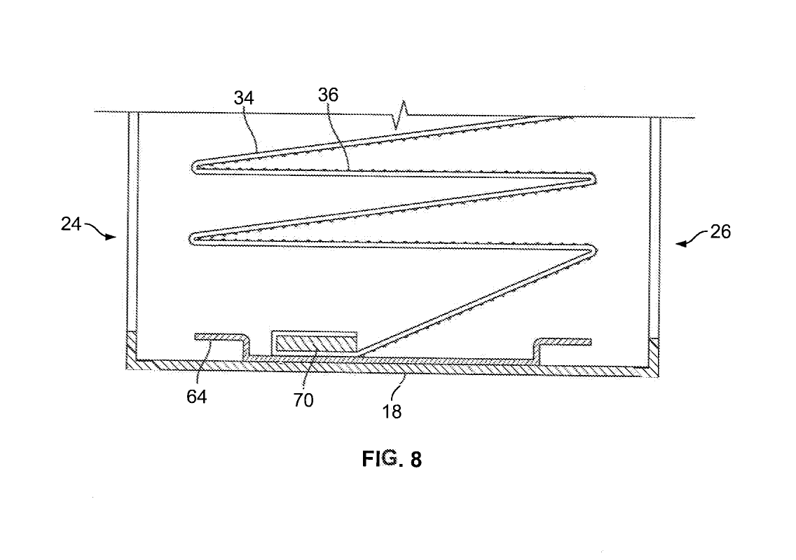

FIG. 8 illustrates an alternative lower end or bottom hold-down. Unlike the FIG. 6 embodiment, the alternative embodiment of FIG. 8 does not include an end cap. Rather, an elongated hold-down member 70 is attached to the lower end of the filter media 34 and/or flexible support 36. Attachment can be adhesive, or by forming a loop in the filter media or by any other means. Member 70 is preferably a metal rod, bar, pipe or other configuration, and has sufficient weight, e.g., at least 5 oz per lineal foot, to hold-down the bottom of the filter within the enclosure 12. Optionally, hold-down member 70 can be magnetized so as to be magnetically attachable to the steel bottom of enclosure 12. As a result, the bottom end of the filter is secured to the bottom of the enclosure 12 by the weight of the hold-down member, or by magnetic attachment, or by a combination thereof.

The magnets and/or weighted end cap or hold-down member facilitate installation of the filter into to the frame enclosure 12. Conventional filters, as shown for example in U.S. Pat. No. 8,157,881, require a user (home owner or HVAC maintenance personnel) to simultaneously align and insert both the top and bottom end caps into the respective top and bottom tracks of the frame enclosure, which can be cumbersome. With the subject filter embodiment, the user inserts only the top end cap 48 into top guide track 30, while holding the filter in a compressed configuration. Once the top end cap is fully inserted in the top track, the user releases the filter allowing it to drop, expanding within the filter frame enclosure. The bottom of the filter is held down by gravity and/or by automatic magnetic attachment to the steel bottom of the filter enclosure. Similarly, replacing filters is easier. When removing an old filter from the frame the magnet attachment of the bottom member is easily released by the user. Accordingly, the weight and magnetic attachment of the bottom end cap facilitates filter installation and replacement.

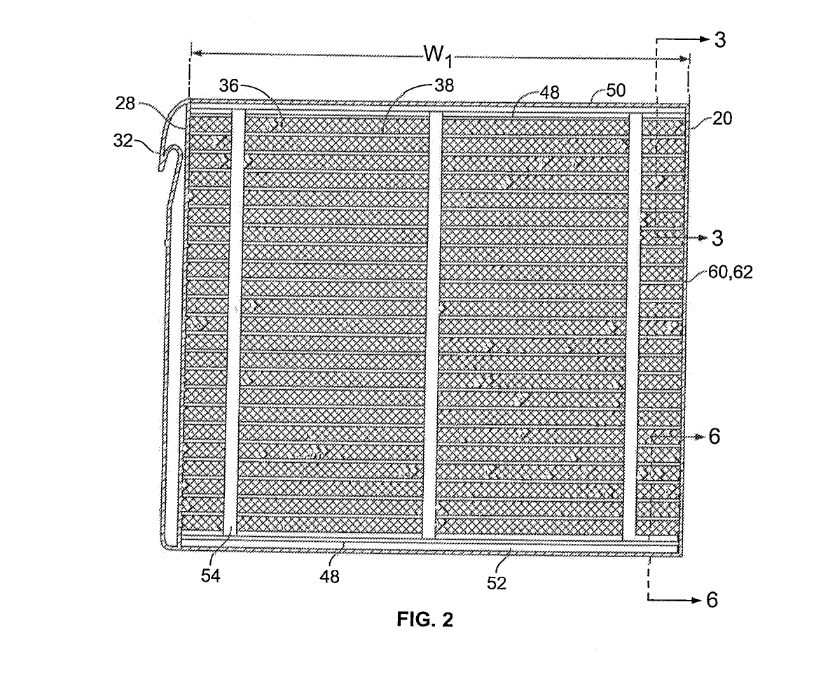

FIG. 2 shows the filter 14 installed in the enclosure 12. The enclosure 12 has an interior width of W₁, measured as the distance from the interior surface of the rear wall 20 to the interior surface of the door 32 when the door is closed.

The filter 14 can optionally include one or more pleat spacer members 54 that extend between the end caps 48 and are connected to the end caps and the pleat edges 38. The spacer member 54 functions to maintain uniform pleat spacing and provides structural support to the filter 14. Multiple spacer members 54 can be provided on one or both sides of the filter 14.

Turning now to FIGS. 5A-5C, the filter media layer 34 and the support member 36 are shown. In FIG. 5A, the unpleated, flat support member 36 is shown attached to the flat, unpleated filter media layer 34. The support member 36 has a width W₂ measured as the distance between side edges 40 and 41 of the filter support member 36. The filter media layer 34 includes side edges 56 and has a width W₃ measured as the distance between the side edges of the filter media layer. The width W₃ is greater than W₂. Preferably, the support member 36 is centered on the filter media layer 34 in the width direction. Preferably, the filter media layer 34 completely covers one side of the support member 36. As shown in FIG. 5A, the filter media layer 34 includes skirt portions 58, which are portions of the filter media layer that extend beyond the side edges 40 and 41 of the support member 36.

As shown in FIGS. 5B-5C, the skirt portions 58 of the filter media layer 34 are folded over the side edges 40, 41 of the support member 36. The skirt portion 58 covers and is folded over the side edges 40, 41 to a portion of a second side 46 of the support member 36. Preferably, the skirts 58 are folded over the side edges 40, 41 and are adhered or otherwise attached to the downstream surface of the support member 36. However, it is not necessary that the skirts 58 be attached to the second side 46 of the support member 36. A filter media cushion is thereby formed covering the side edges 40, 41 of the support member 36. The filter media cushion 60 prevents the end user from coming into contact with the side edges 40, 41 of the support member 36, which can be sharp and cause injury. The filter media cushion 60 also helps form an effective seal between the filter 14 and the enclosure 12, as described below.

The filter 14 has a finished width W₄ measured as the distance between the filter media cushions 60. In some embodiments width W₄ is equal to or slightly greater than the width W₁ of the enclosure 12, but in other embodiments W₄ may be equal to or slightly shorter than the width W₁ of the enclosure. Further, the finished width W₄ is greater or substantially equal to the width W₂ of the support member 36. In other words:

W₂≦W₁

W₁≈W₄

W₂≦W₄

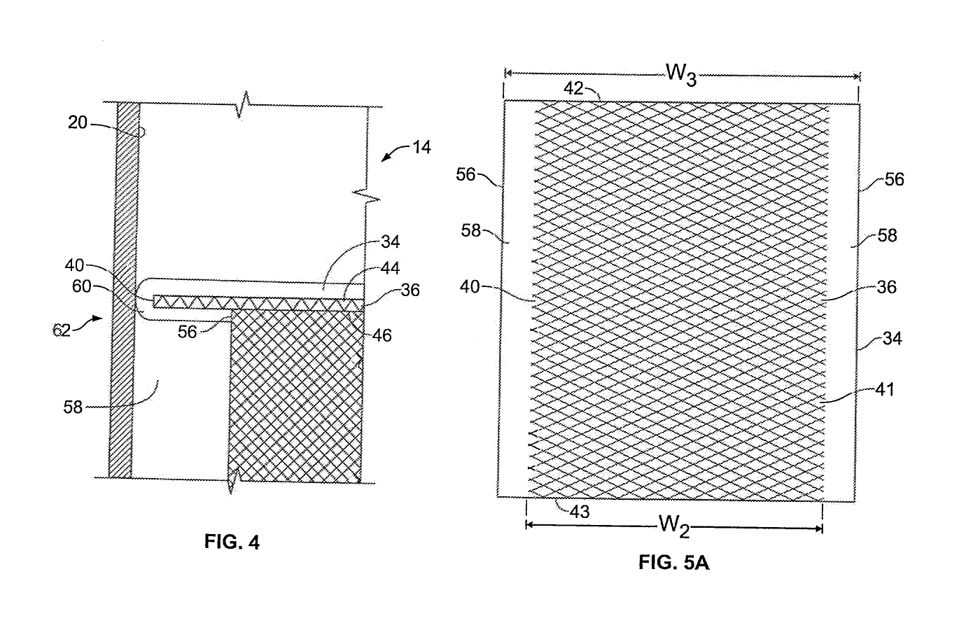

In embodiments where the width W₄ of the filter 14 is equal to or slightly greater than the width W₁ of the enclosure 12, the filter 14 may closely fit within or be slightly compressed in a width direction in order to fit into the enclosure 12. Specifically, cushions 60 represent the difference between W₂ and W₄. In other words, the difference between the width W₄ and the width W₂ is the added dimension of the one or more filter media cushions 60. As shown in FIG. 4, when the filter 14 is inserted into the enclosure 12, the filter media cushion 60 forms a compression point 62 where the filter media cushion contacts the rear wall surface 20 and/or the door 32. The support member 36 being more rigid than the filter media layer 34 is less likely to deform. Because of the seal formed at point 62, air flowing through the ductwork is directed to pass through the fitter 14.

As shown in FIG. 4, the filter media layer 34 is folded over the side edges 40, 41 of the support member 36. The filter media cushion 60 covers the side edges 40, 41 of the support member 36. As the filter 14 is inserted into the enclosure 12, the filter media cushion 60 will conform to the rear wall 20, compressing the filter media at point 62. This compression point 62 allows the filter 14 to form an effective seal with the enclosure 12.

In embodiments where the finished width W₄ of the filter 14 is equal to or slightly less that the width W₁ of the enclosure, the cushions will not be compressed, but an effective seal can still be formed as the gap if any between the filter and enclosure wall is minimal.

It should be appreciated that the term “effective seal” encompasses exemplary embodiments where air flowing from the air-inlet opening 24 to the air-outlet opening 26 directed primarily through the filter 14, rather than around it. It should be appreciated that the term “effective seal” does not necessarily mean that no air flows between around the filter media.

While only certain embodiments have been set forth, alternative embodiments and various modifications will be apparent from the above description to those skilled in the art. These and other alternatives are considered equivalents and within the spirit of scope of the present invention.

1. A filter for an air cleaner including a filter enclosure having a top guide track and a bottom, the filter comprising:
a pleated and collapsible filter media configured to be positioned in the filter enclosure;
a top end cap connected to one end of the filter media and being configured for mechanical connection to the top channel of the enclosure; and
a bottom end member connected to the other end of the filter media, the bottom end member being configured for holding down the bottom of the filter media within the filter enclosure.

2. A filter as in claim 1, wherein the bottom end member has a weight of at least 5 oz per lineal foot in the width direction.

3. A filter as in claim 1, wherein at least the bottom of the filter enclosure is comprised of a ferrous metal,
wherein the bottom end member comprises a bottom end cap connected on an inner side to the filter media and having magnets on an outer side for magnetic attachment to the bottom of the filter enclosure.

4. A filter of claim 1, wherein the filter media comprises:
a flexible support member having first and second surfaces and side edges; and
a filter media layer attached to the first surface of said support member, said media layer when unfolded extending beyond the side edges of the support member to form skirts, wherein the skirts are folded over the side edges of the support member and are attached to the second side of the support member.

5. The filter of claim 4, wherein the skirts that are folded over the side edges of the support member forms filter media cushions along the side edges of the flexible support member, which cushions are compressible to conform to the enclosure when the filter is inserted into the enclosure.

6. A filter of claim 4, wherein the enclosure has a width W₁, and wherein the support member has a width of W₂ that is less than W₁; and the filter media has a width of W₄ that is greater than or equal to W₁.

7. A filter of claim 4, wherein the enclosure has a width W₁, and wherein the filter media has a width of W₄ that is equal to or slightly smaller than W₁.

8. A filter of claim 3, wherein the bottom end cap has at least one pair of ribs running the width of the end cap.

9. A filter of claim 8, wherein the ribs are parallel to one another on an inner surface of the bottom end cap and the filter media is attached to the bottom end cap in between the ribs.

10. A filter of claim 8, wherein at least the bottom of the filter enclosure is comprised of a ferrous metal,
wherein the ribs are on an outer surface of the bottom end cap, and a plurality of the magnets are attached to the outer surface of the bottom end cap in between the pair of ribs, at least one magnet abutting each rib.

11. A filter of claim 1, wherein at least the bottom of the filter enclosure is comprised of a ferrous metal,
wherein the bottom end member is unitarily formed of a material having magnetic properties.

12. A filter of claim 11, wherein at least the bottom of the filter enclosure is comprised of a ferrous metal,
wherein the bottom end cap is extruded plastic having magnetic properties.

13. A filter of claim 1, wherein at least the bottom of the filter enclosure is comprised of a ferrous metal, and wherein the bottom end member comprises
an extruded plastic base member having
a first pair of ribs parallel to one another on an inner surface of the base member, the filter media being attached to the base member in between the first pair of ribs, and
a second pair of ribs parallel to one another on the outer surface of the base member, and
at least one magnet being attached to the outer surface of the base member in between and abutting at least one of the second pair of ribs.

14. A filter of claim 1, wherein the bottom of the filter enclosure comprises a pair of steel spaced apart guide tracks, and wherein the bottom end member comprises
a base member, and
at least a first pair of magnets attached to the outer surface of the base member and configured to magnetically attach to the pair of guide tracks, respectively.

15. A filter of claim 1, wherein the bottom end member comprises
an extruded plastic base member, and
at least one weight attached to the plastic base member.

16. A filter for an air cleaner including a filter enclosure having a width W₁, top and bottom guide tracks, at least the bottom track being comprised of a ferrous metal, wherein the air cleaner is configured to cause air to flow through the enclosure from an upstream to a downstream direction, the filter comprising:
a flexible metal support member having a first and second side edges, the support member having a width W₂ substantially equal to but less than W₁;
a filter media layer connected to and covering at least one side of the support member and having an unfolded width W₃ greater than W₂, such that the filter media when unfolded extends beyond said first and second side edges of the support member forming filter media skirts;
wherein the filter media skirts are folded over the respective first and second side edges of the support member so as to cover the side edges and form filter media cushions on the side edges of the filter, the filter with folded over skirts having a width W₄ that is substantially equal W₁;
wherein the filter is configured to be positioned in the enclosure with the support member downstream from the filter media with respect to the direction of airflow;
wherein the filter is pleated and collapsible;
a top end cap connected to a top end portion of the filter, the top end cap being configured for slideable engagement into the top guide track of the filter enclosure; and
a bottom end cap connected on an inner surface to a bottom end portion of the filter, and having at least one magnet on an outer surface, the magnet being configured for magnetic attachment to the bottom guide track of the filter enclosure.

17. A method of making a filter, comprising
providing a flexible support member having a width W₂ between side edges,
providing a layer of filter media having a width W₃, W₃ being greater than W₂,
attaching the support member to the filter media so that the filter material extends beyond the side edges of said support member forming filter media skirts,
folding the filter media skirts over the side edges of the support member to cover the side edges and attaching the skirts to the other side of the support member to form a composite filter media,
pleating the composite filter media,
forming a top end cap being configured to be slidably attached to guide tracks of a filter enclosure,
attaching the top end cap to the composite filter media, and
attaching a hold-down member to the bottom of the composite filter media.

18. A method as in claim 17 further comprising
extruding the hold-down member having a base member, and
attaching magnets an outer surface of the base member.

19. A method as in claim 18 further comprising attaching a weight to the base member.

20. A method of replacing a filter in a filter frame enclosure having a top guide track and a bottom, comprising
providing a replacement filter comprised of a pleated, collapsible filter having a top end cap and a bottom hold-down member,
opening the filter frame enclosure,
removing an old filter from the filter frame enclosure,
guiding the top end cap only of the replacement filter into the top guide track of the filter frame enclosure,
sliding the replacement filter into the filter frame enclosure with the filter in at least a partially collapsed configuration,
releasing replacement filter allowing the bottom of the filter to drop within the filter frame enclosure.

21. A method as in claim 20, wherein the bottom hold-down member is magnetized and further comprising the step of
magnetically attaching the hold-down member to a ferrous metal bottom of the filter frame enclosure.
